(19) United States
(12) Patent Application Publication
(10) Pub. No.: US 2002/0076512 A1
(43) Pub. Date: Jun. 20, 2002

(54) Handheld device, applique therefor and methods of making the same

(76) Inventor: Cheryl Kreider, Springfield, MO (US)

Correspondence Address: RICHARD L. MARSH, 4116 E. LATOKA, SPRINGFIELD, MO, 65809, US

(21) Appl. No.: 09/737,543

(22) Filed: Dec. 14, 2000

(51) Int. Cl. B32B 3/10

(52) U.S. Cl. 428/34.1; 428/138

(57) ABSTRACT

An applique is adhesively affixed to at least one face of a hand held device wherein the hand held device comprises a case housing electronic components. The case is a cubic structure having at least one contoured surface on at least one face thereof wherein the face further has a plurality of means for actuating disposed thereon for operating the portable device. The appearance of the face of the hand held device is changed by the application of the applique thereto wherein the applique is selected from a group of appliques permitting the owner of the hand held device to personalize the hand held device.

### BACKGROUND OF THE INVENTION

1. Field of the Invention

This invention relates to a hand held device having at least one set of keys on at least one face thereof adapted to actuate the hand held device and a disposable, replaceable applique for the at least one face.

2. Prior Art Statement

Hand held devices having at least one set of actuating keys or buttons on at least one face thereof are widely used by people world wide. For instance, home entertainment devices have employed a remote operating device for many years. Portable telephones, whether used with a local base unit or linked to a satellite have become popular in recent years, these portable telephones being provided by the manufacturers thereof in various colors, styles and shapes. Many portable telephones have become extensions of one's personality as well as providing the necessary personal or business link desired by the owner. As an extension of one's personality, the user of a cellular telephone may wish to have the band held device, especially the cellular telephone, to express the personality of the user, however, in most instances, the warranty of the hand held device is voided by opening the device, for instance, to exchange the face plate thereof with a face plate from another hand held device of the same make and model. Thus, the user is effectively prevented from personalizing the hand held device.

Various means of providing a decorative applique to the planar surface of a standard push-button desk telephone are known wherein the faceplate has a slot for receiving the decorative applique or wherein an adhesive backed applique is applied to the planar removable faceplate or to the substrate below the faceplate or wherein the decorative faceplate may extend over the side edges of the telephone. For instance, see the U.S. Pat. No. 4,292,481 issued on Sep. 29, 1981, to Barnes, et al or the U.S. Pat. No. 5,113,435 issued on May 12, 1992 to Yung-Huei Chen or the U.S. Design Pat. D309,901 issued on Aug. 14, 1990 to Jeannine Ceaser. The means described in these patents are adapted to fit onto or within planar surfaces of the underlying unit.

It is also known to provide a metallic or thermoplastic cover plate having an adhesive on the reverse side a planar portion of an automotive dashboard. Similar planar cover plates with indicia thereon are found on calculators, TV, VCR or audio system remote control devices. For instance, see the U.S. Pat. No. 4,560,602 issued on Dec. 24, 1985 to David L. Draper. These planar cover plates are permanently affixed to the underlying unit and having cutout portions for elements of the underlying unit protruding through the cover plate.

It is further known to provide an applique for the upper surface of a ski having raised surfaces throughout the length and width thereof suggesting that it is made of a thicker material having an adhesive backing for application to the ski. For instance, see U.S. Design Pat. D282,387 issued on Jan. 28, 1986 to Oswald Pichler. The applique is applied only to the planar portion of the cross-country ski.

Thomas Schaeffler, in his U.S. Design Pat. D370,939 issued on Jun. 18, 1996 shows individual decal elements of a larger decoration applied to the spaces between the frets on a guitar neck. The decal elements are planar and are applied individually between the frets.

Additionally, it is known to claim a display system for a portable telephone comprising a cover overlying a housing, a transparent window member, a first removable collar and a fixing collar attachable to the cover wherein the four components may be different in color, design, texture or other surface differences. For instance, see the U.S. Pat. No. 5,768,370 issued on Jun. 16, 1998 to Mata, et al., or the U.S. Design Pat. D394,439 issued on May 19, 1998 to Mischenko, et al. The display system of these inventions are relatively expensive and require storage for the display system(s) not in use.

A set of decorative appliques for the planar surfaces of a computer are shown and claimed in U.S. Design Pat. D398,158 issued on Sep. 15, 1998 to Ira M. Marks. These decorative appliques are planar and do not require contour specific features.

A. fishing lure decal is shown in U.S. Pat. No. 5,858,494 issued on Jan. 12, 1999 to Cherkas, et al. The fishing lure decal may be selected from a sheet of different decals and be applied to the side of the lure and/or the blade. These decals are removable but do not have contour specific features.

Currently, it is common practice to change the appearance of a cellular phone by removing the entire face plate and replacing the same from a plurality of selected faceplates. For instance, see the U.S. Pat. No. 5,982,881 issued on Nov. 9, 1999 to Nicholas Mischenko. The faceplates described and claimed in Mischenko are relatively expensive and require storage for the face plate(s) not in use.

Finally, it is known to provide a repositionable housing sticker for a face plate or a repositionable LCD 3D Hologram Sticker for the planar display window of a cellular phone. For instance, see www.progrex.globalsources.com. Although the hologram sticker is removable, it is planar in contour and does not have contour specific features and the repositionable housing sticker is a generally translucent film material which peels easily therefore often curling along the edges or becoming accidently removed.

### SUMMARY OF THE INVENTION

The prior art described above has not allowed an owner of a portable device to effectively and readily personalize the portable device. The numerous citations all lack an easy method of selecting, applying, and when desired, removing a personally selected or personalized applique directly to the outer surface of at least one face of the portable device. Therefore, it is an object of this invention to provide a portable device comprising a case housing electronic components wherein the case comprises a cubic structure having at least one contoured face and further having a plurality means for actuating disposed thereon for actuating the portable device wherein the appearance of at least one face of the case is changeable by removably affixing one of a plurality of decorative appliques thereto wherein the decorative applique has apertures disposed therein for accessing the plurality of means for actuating therethrough.

Still another object of this invention is to provide an applique for any exterior face of a hand held device wherein removal of any component of the hand held device is unnecessary, thus retaining the warranty of the hand held device.

An object of this invention to provide a portable device comprising a case housing electronic components wherein the case comprises a cubic structure having at least one contoured face and further having a plurality means for actuating disposed thereon for actuating the portable device wherein the face having the plurality of means for actuating therein is contoured from one edge thereof to an opposite edge thereof wherein the appearance of the face of the case is changeable by removably affixing one of a plurality of decorative appliques thereto.

Another object of this invention to provide a portable device comprising a case housing electronic components wherein the case comprises a cubic structure having at least one contoured face and further having a plurality means for actuating disposed thereon for actuating the portable device wherein the face having the plurality of means for actuating therein is contoured from said one edge thereof to said opposite edge thereof and is further contoured from one end to an opposite end thereof.

A goal of this invention is to provide a portable device having at least one face contoured from one edge thereof to the opposite edge thereof and from one end thereof to the opposite end thereof also has contoured depressions disposed downwardly into the face and/or contoured elevations disposed upwardly from the face between the one edge and the opposite edge and between the one end and the opposite end wherein the face has a decorative applique applied thereto.

Another goal of this invention is to provide a portable device having at least one face contoured from one edge thereof to the opposite edge thereof and from one end thereof to the opposite end thereof also having contoured depressions disposed downwardly into the face and/or contoured elevations disposed upwardly from the face between the one edge and the opposite edge and between the one end and the opposite end wherein the face has an applique applied thereto that conforms to the contoured face and is applied to the contoured face from the one edge to the opposite edge, from the one end to the opposite end and around the means for actuating, depressions and elevations.

Still another object of this invention is to provide a portable hand held device such as a cellular telephone, the portable device comprising a case housing electronic components wherein the case comprises a cubic structure having at least one contoured face and further having a plurality means for actuating disposed thereon for actuating the portable device wherein the appearance of at least one face of the case is changeable by removably affixing one of a plurality of decorative appliques thereto wherein the decorative applique has apertures disposed therein for accessing the plurality of means for actuating therethrough and wherein the portable device is adapted for communication with a base unit, the case housing electronic components to effect communication with the base unit, the portable device having each aperture of the decorative applique individually contoured around each of the plurality of means for actuating.

Yet another object of this invention to provide a portable device comprising a case housing electronic components wherein the case comprises a cubic structure having at least one contoured face and further having a plurality means for actuating disposed thereon for actuating the portable device wherein the face having the plurality of means for actuating therein is contoured from one edge thereof to an opposite edge thereof wherein a decorative applique previously applied to the face is removed therefrom and another applique is applied thereto thus providing means for changing the appearance of the face.

An aim of this invention is to provide a portable device having a case housing electronic components, the case comprising a cubic structure having at least one contoured face wherein the face further has a plurality of means for actuating thereon and wherein the appearance of the face is changed by affixing one of a plurality of decorative appliques thereto, the decorative applique having apertures disposed therein for accessing the means for actuating therethrough and wherein the portable device has one of the plurality of decorative appliques applied to at least one other face thereof.

It is readily apparent that another goal of this invention is to provide an applique adapted to be adhesively affixed to at least two faces of a hand held device wherein an applique applied to one of the faces thereof may have personalization thereon.

Yet another goal is to provide personalization on an applique on at least one face of a hand held device wherein the personalization indicates the owner, lessee or lessor of the hand held device and/or carries an advertisement, photograph or other personalization thereon.

Still another aim of this invention is to provide an applique adapted to be adhesively affixed to at least one face of a hand held device wherein the hand held device comprises a case housing electronic components, the case comprising a cubic structure having at least one contoured surface on the at least one the face thereof, the at least one the face further having a plurality of means for actuating disposed thereon, the plurality of means adapted to actuate the portable device, the appearance of the face of the hand held device changed by application of the applique thereto, the applique selected from a group of appliques permitting the owner of the hand held device to personalize the hand held device wherein the applique is removed from a carrier sheet while leaving an applique conforming to each the apertures upon the carrier sheet.

A significant feature of this invention is to provide an applique adapted to be adhesively affixed to at least one face of a hand held device wherein the applique has means for permitting the applique to conform to the contoured surface wherein the means for permitting comprises a slit between at least two of the apertures.

Still another significant feature of this invention is to provide an applique adapted to be adhesively affixed to at least one face of a hand held device wherein the at least one the face has at least one contoured side edge and at least one contoured end, the at least one contoured end having a depression formed into the face and/or formed upon the face adjacent the at least one contoured end wherein the slit is disposed between the at least one end and the depression.

Additionally, it is an object of this invention to provide an applique adapted to be adhesively affixed to at least one face of a hand held device wherein the at least one face has at least one contoured side edge and at least one contoured end wherein the at least one contoured end has an elevation formed upon the face adjacent at least one means for actuating wherein a slit in the applique is disposed between the means for actuating and the elevation.

Still further, an object of this invention is to provide a cellular telephone having a faceplate and an applique applied to the faceplate, the faceplate having at least one curved edge and at least one curved end, the faceplate further having a depressed surface adjacent the at least one curved end, the applique conforming to the curved edge and the curved end, the applique further having means for surrounding the depressed surface wherein the depressed surface is an ear piece of the cellular telephone.

Finally, it is an object of this invention is to provide a cellular telephone having a faceplate and an applique applied to the faceplate, the faceplate having at least one curved edge and at least one curved end, the faceplate further having an elevated surface upon the face thereof the applique conforming to the curved edge and the curved end and further having means for surrounding the elevated surface wherein the elevated surface is a display screen of the cellular telephone.

It will become apparent that another object of this invention is to provide an applique for a hand held device wherein the hand held device has means for actuating protruding from at least one face thereof wherein cutouts in the applique surround the means for actuating protruding above the face.

Another object of this invention is to provide an applique for a hand held device wherein tie hand held device has means for actuating recessed into at least one face thereof or wherein the means for acing are coplanar with contoured surface of at least one face the applique having cutouts surrounding the area of each of the means for actuating.

### BRIEF DESCRIPTION OF THE DRAWINGS

FIG. 1 is a perspective view of a hand held device having an applique of this invention shown suspended in space above one face of the hand held device.

FIG. 2 is a perspective view of the preferred embodiment of the applique of this invention showing the applique suspended above the carrier sheet after having been removed therefrom and showing the applique cutouts of the apertures remaining on the carrier sheet.

### DESCRIPTION OF THE PREFERRED EMBODIMENTS

While the various features of this invention are hereinafter described and illustrated as a portable device adapted for communication with a base unit, the portable device having a case housing electronic components to effect the communication with the base unit, the case further having actuating means on at least one face thereof wherein the appearance of at least one face of the case is changeable by removably affixing one of a plurality of substantially flat decorative appliques thereto, the flat decorative applique having apertures disposed therein for accessing the actuating means therethrough, it is to be understood that the various features of this invention can be used singly or in various combinations thereof a portable device having a case housing electronic components and further having actuating means on at least one face thereof wherein the appearance of at least one face of the case is changeable by removably affixing one of a plurality of substantially flat decorative appliques thereto, the flat decorative applique having apertures disposed therein for accessing the actuating means therethrough as can hereinafter be appreciated from a reading of the following description.

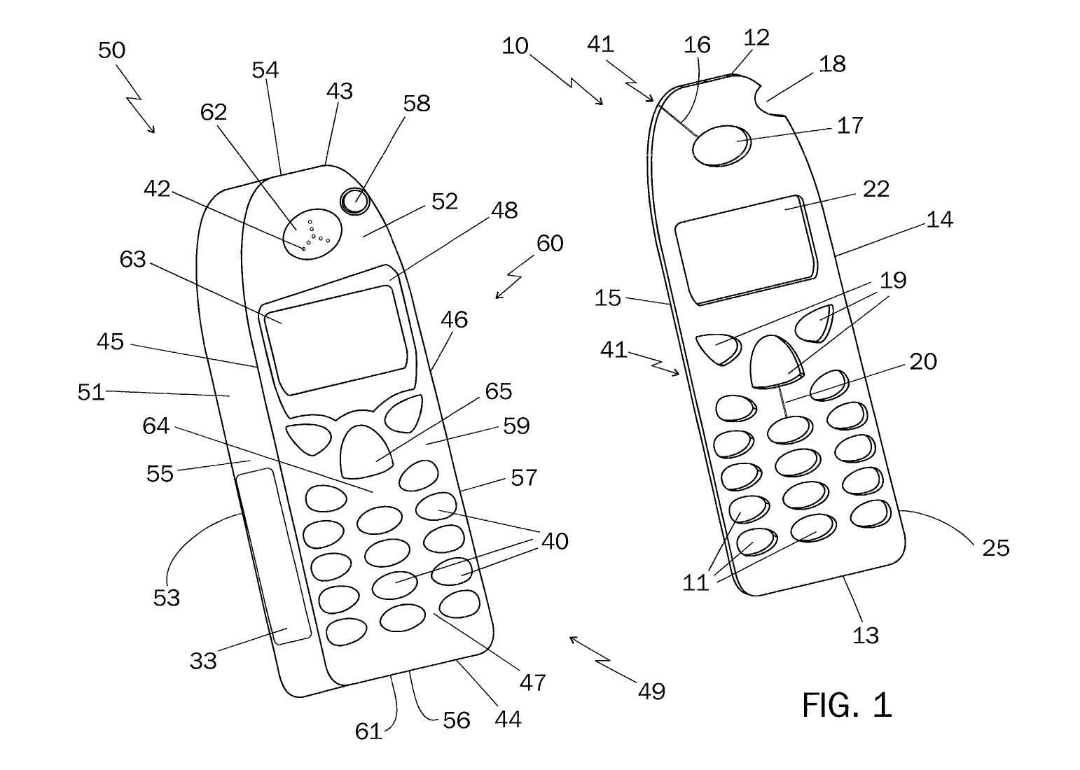

Referring now to FIG. 1, a portable device generally described with the numeral 50 has a case 51 housing electronic components, case 51 comprising a cubic structure having at least one face 52 being a contoured face 59 though any or all of the other faces 53, 54, 55, 56 or 57 may be contoured as well. At least one face, also preferably front face 52 further has a plurality means 49 for actuating thereon adapted for operating portable device 50. Means 49 for actuating generally comprises a series of actuating buttons 40 often arranged in rows and columns, keys 65 and a power button 58, actuating buttons 40, menu keys 65 and power button 58 protruding above an upper surface 47 of front face 52. Hand held device 50 may further have a raised or elevated portion 48 on one face 52-57, elevated portion 48 shown on face 52 in FIG. 1. Elevated portion 48 may further have a display screen 63 associated therewith, display screen 63 showing various print media stored within hand held device 50 or entered upon actuating buttons 40. More than one elevated portion 48 may exist on face 52 such as portion 64 surrounding at least one other of keys 65 of means 49 for actuating. Keys 65 may be a set of menu keys for displaying the various features of the hand held device upon screen 63.

FIG. 1 also includes an applique generally shown with the number 10 for changing the appearance of at least one face 52-57 of case 51 by removably affixing one of a plurality of decorative appliques 10 thereto wherein each decorative applique 10 has a plurality of apertures 11 disposed therein for accessing plurality of means 49 for actuating therethrough. Additional apertures are provided in applique 10 for depressed portion 42, display screen 63 of raised portion 48 and menu keys 65 these apertures shown in FIG. 1 & 2 as numerals 17, for depression 42, numeral 22 for display screen 63 and numeral 19 for menu keys 65. Furthermore, a notch 18 is removed from applique 10 for access to a power button 58.

Portable device 50 having contoured face 59 and plurality of means 49 for actuating disposed thereon is preferably contoured from one edge 45 thereof to an opposite edge 46 thereof wherein the appearance of face 52 of case 51 is changeable by removably affixing of a decorative applique 10 thereto. Specifically, face 59 is preferably continuously curved from edge 45 to opposite edge 46, wherein face 59 has a smooth, large radius curve across most of the surface thereof and is curved at a small radius at edges 45 and 46, edge 45 effectively blending into side 55 and opposite edge 46 effectively blending into side face 57 though this blending is omitted from FIG. 1 for clarity. Likewise, contoured face 59 may also be contoured from one end 43 to a bottom end 44 thereof but more specifically, bottom end 44 is curved at a small radius downwardly near bottom face 56 and blended into bottom face 56 while end 43 is curved at a small radius downwardly near top face 54 and blended into top face 54. Moreover, face 54 is generally curved from side face 55 to side face 57 giving a rounded shape to case 51. Though face 52 of case 51 generally has a convex contour wherein contoured surface 59 is convex from edge 45 to edge 46 and/or from end 43 to end 44, contoured surface 59 may be concave over a portion thereof thereby necessitating a modification to the cutting die in order to accommodate the change in contour around any of protruding portions 40 and/or 64, depression 42 or raised portions 48, 65.

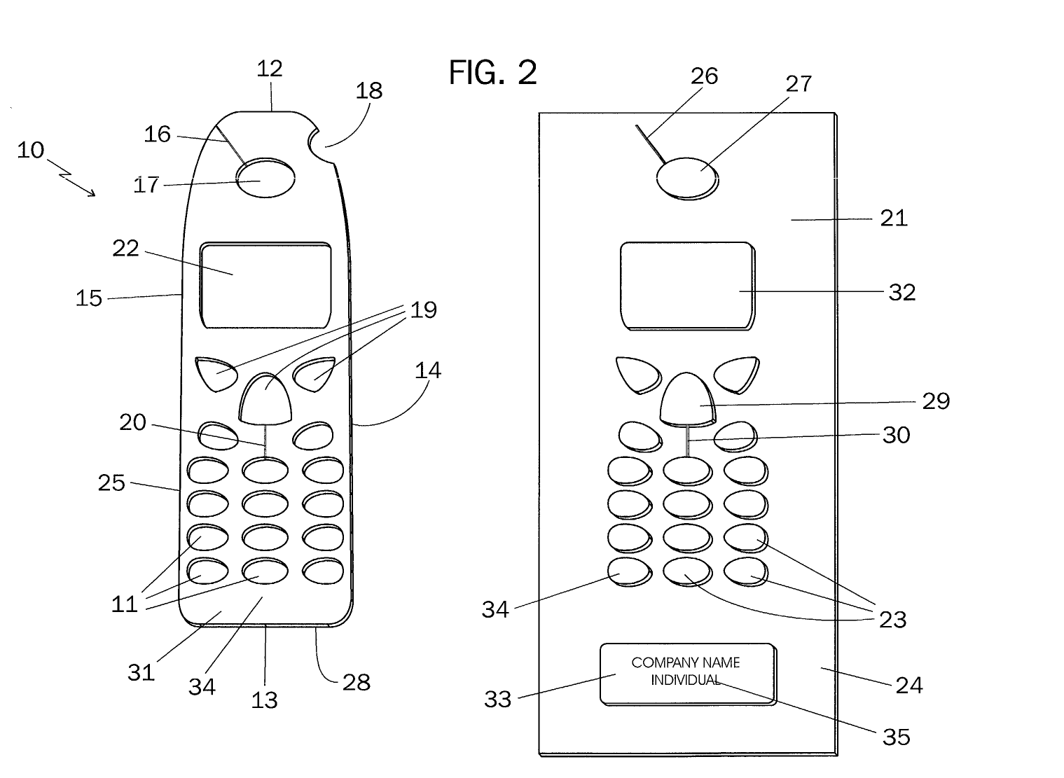

Decorative applique 10 for portable device 50 is applied to contoured face 59 such that decorative applique 10 conforms to contoured face 59 from one curved edge 45 to opposite edge 46 and from top end 43 to bottom end 44. Decorative applique 10 also has apertures 11 disposed around means 49 for actuating buttons 40 with aperture 17 disposed around depression 42 and aperture 22 disposed around display screen 63 of elevation 48 though aperture 22 could be enlarged to conform to elevated surface 48. As face 59 is preferably curved across the entirety thereof from at least edge 45 to edge 46, each aperture 11, 17 and 22 is cut into an applique material 25 carried on a carrier 21 slightly larger than the apparent surface area of the corresponding element being surrounded as applique material 25 is cut on a flat surface. For instance, each of actuating buttons 40 may be generally oval in shape as shown in FIG. 1 wherein each actuating button 40 has a specified surface area, however, in order to allow for the curve of contoured surface 59, apertures 11 on applique 10 are cut having a greater length to the major axis of the oval and may also have a slightly greater length to the minor axis thereof. Similarly, aperture 22 for surrounding display screen 63 is generally cut into applique material 25 with a slightly greater length in the direction from side edge 15 toward side edge 14 to allow for the slight curvature of contoured face 59. In the case of menu keys 65, apertures 19 are also cut slightly larger than the areas around menu keys 65 but a means 41 for permitting applique 10 to conform to elevated surface 48 is also cut into applique material 25. Specifically, means 41 for permitting comprises a slit 20 cut between at least one of apertures 19 and at least one of apertures 11 to allow applique 10 to conform to elevated surface 64 surrounding keys 65. Only one slit 20 is shown in FIGS. 1 and 2 between apertures 19 and apertures 11, however, slit 20 may also be provided between any or all of apertures 19 and/or between any or all of apertures 19 and adjacent apertures 11 and/or between any or all of apertures 11. Thus, portable device 50 has each aperture 11 of decorative applique 10 individually contoured around each of the plurality of means 49 for actuating portable device 50, applique 10 fully conforming to the curvature of contoured surface 59.

Means 41 for permitting applique 10 to conform to contoured surface 59 may also be provided between aperture 17 and top end 12 of applique 10 in order for applique 10 to be fitted around depression 42. It should be fully appreciated here that as contoured surface 59 is curving sharply downwardly along top end 43 to blend with face 54, the length along top end 12 of applique 10 must be allowed to lengthen from the length as cut into the flat piece of applique material 25. Thus, means 41 for permitting applique 10 to conform to top end 43 of contoured surface 59 comprises a slit 16 between aperture 17 and top end 12 of applique 10. Slit 16 may be a single cut through applique material 25 but preferably comprises a pair of spaced apart, parallel cuts through applique material 25 at the location of slit 16 thus leaving a narrow strip 26 of applique material 25 upon carrier 21 as shown in FIG. 2. Similarly, slit 20 comprises a pair of spaced apart, parallel cuts through applique material 25 at the location of slit 20 leaving a narrow strip 30 of applique material 25 upon carrier 21 at the location of slit 20.

Preferably, decorative applique 10 is adapted to be adhesively affixed to at least one face 52-57 of portable device 50 wherein portable device 50 is a hand held device such as a cellular telephone, television, VCR, DVD or audio remote, tape recorder, personal data assistant, calculator or the like wherein the hand held device comprises case 51 housing electronic components, case 51 comprising a cubic structure having at least one contoured surface 59 on one face 52-57 thereof. Face 52 is generally a front face of portable device 50 and further has a plurality of means 49 for actuating disposed thereon, plurality of means 49 adapted to actuate portable device 50. Decorative applique 10, when adhesively applied to face 52 changes the appearance of face 52 of hand held device 50 by application of applique 10 selected by the owner of portable device 50 from a group of appliques 10 thereby permitting the owner of portable device 50 to personalize portable device 50 wherein applique 10 is removed from a carrier sheet 21 while leaving cutout portions 23, 27, 29 and 32 conforming to apertures 11, 17, 19 and 22 upon carrier sheet 21. Thus, as is readily observed in FIG. 2, applique 10 comprises a thin sheet of material 25 having apertures 11, 17, 19 and 22 therethrough from a top side surface 31 through a back side surface 28 when removed from carrier 21 with carrier 21 retaining cutout portions 23, 27, 29 and 32. Carrier 21 may also retain narrow strip cutouts 26, 30 wherein these narrow strip cutouts 26, 30 provide for slits 16, 20 respectively in applique 10. Applique 10 having slits 16, 20 therein is readily adaptable to a raised or depressed surface spanning the area therearound. For instance, slit 16 allows applique 10 to conform to rounded top end 43 of portable device 50 such as a cellular telephone 60 having a faceplate, the faceplate having at least ore curved edge 45 and at least one curved end 43, the faceplate further having depressed surface 42 adjacent curved end 43, applique 10 conforming to curved edge 45 and curved end 43, applique 10 surrounding depressed surface 42 wherein depressed surface 42 is an ear piece 62 of cellular telephone 60. Likewise, applique 10 may be adhesively affixed to face 52 of cellular telephone 60 wherein face 52 has an elevated portion 64 formed upon face 52 adjacent at least one of means 49 for actuating wherein slit 20 is disposed between an aperture 11 adapted to surround the at least one means 49 for actuating applique 10 conforming to elevated portion 64. For instance, in a cellular telephone 60, elevated portion 64 generally surrounds menu keys 65 wherein menu keys 65 are elevated above the upper level of actuating buttons 40 of means 49 for actuating. Thus, a planar applique will wrinkle when applied to elevated portion 64 and it is necessary to provide for relief in the area of elevated portion 64. Slit 20 therefore is provided between at least one of apertures 19 for menu keys 65 and at least one of apertures 11 for actuating buttons 40 allowing applique 10 to conform to elevated surface 64.

Applique 10 preferably has a semi-permanent adhesive applied to backside surface 28 thereof and is generally not repositionable once applied to face 52. However, the semi-permanent adhesive allows one decorative applique 10 previously applied to face 52 to be removed therefrom and another applique 10 applied thereto thus providing means for changing the appearance of face 52. As decorative applique 10 has a semi-permanent adhesive on backside surface 28, decorative applique 10 adheres readily to face 52 and provides for a long lasting changed appearance to face 52 in contrast to repositionable appliques that readily peel away when portable device 50 comes in contact with another object. Thus it has been found by the teachings of this invention that decorative appliques 10 are more durable than repositionable appliques and considerably less expensive than removable face plates known in the art.

Referring still to FIGS. 1 and 2, portable device 50 having one of the plurality of decorative appliques 10 applied to face 52 may further have another of the plurality of decorative appliques 10 applied to at least one other face 53-57 thereof. For instance, face 55 may have a personalized applique 33 applied thereto, personalized applique 33 having personalized information 35 thereon. Though personalized applique 33 is shown on face 55, it is readily apparent that personalized applique 33 may be placed on any other face 53, 54, 56 or 57 of portable device 50, though when placed on bottom face 56, personalized applique 33 may require a series of perforations to allow for access to a microphone 63 disposed in bottom face 61. Preferably, personalized applique 33 is applied to rear face 53. Furthermore, personalized applique 33 may be created on cutout 32 for aperture 22, thus providing for a use of one of cutouts 23, 27, 29 and 32. Likewise, other of cutouts 23, 27, 29 and 32 may be used for other personalization of portable device 50 by placing cutouts 23, 27, 29 and 32 randomly upon other faces 53-57.

It has been found by the teachings of this invention that a cellular telephone 60 having a removable faceplate may have applique 10 applied to the faceplate wherein the faceplate has at least one curved edge 45, 46 and at least one curved end 43, 44 on a face 52 thereof with applique 10 conforming to face 52. The faceplate generally further has an elevated surface 48 thereupon wherein applique 10 conforms to curved edge 45, 46 and curved end 43, 44 and surrounding elevated surface 48 wherein elevated surface 48 is a display screen 63 of cellular telephone 60. The faceplate also generally has depressed surface 42 adjacent curved end 43, applique 10 conforming to curved edge 45 and curved end 43, applique 10 surrounding depressed surface 42 wherein depressed surface 42 is an ear piece 62 of cellular telephone 60. Likewise, applique 10 may be adhesively affixed to face 52 of cellular telephone 60 wherein face 52 has an elevated portion 64 formed upon face 52 adjacent at least one of means 49 for actuating wherein slit 20 is disposed between an aperture 11 adapted to surround the at least one means 49 for actuating, applique 10 conforming to elevated portion 64. For instance, in a cellular telephone 60, elevated portion 64 generally surrounds menu keys 65 wherein menu keys 65 are elevated above the upper level of actuating buttons 40 of means 49 for actuating. Where the faceplate is removable from cellular telephone 60 or other portable device 50, applique 10 may be applied to the faceplate whether the faceplate remains on the portable device 50 or is removed therefrom.

Applique 10 of this invention is generally packaged in pairs with different decorations 34 on each applique 10 in the pair, each applique 10 carried on a separable carrier 21. Preferably, carrier 21 has a treated surface 24 from which applique 10 may be readily removed, carrier 21 with treated surface 24 well known in the art. Applique 10 is a thin sheet of thermoplastic material having decorations 34 on one top side surface 31 thereof decorations 34 comprising any design, pattern, random element, photograph, or the like on any suitable colored background. Applique 10 may also be a thin sheet of fabric, paper, thermoplastic coated or impregnated fabric, paper or other substrate material having decoration 34 on top side surface 31 thereof, however, decoration 34 is preferably permanently incorporated into top side surface 31 of applique 10 and is thus a durable surface for face 52.

As hereinbefore mentioned, applique 10 has a semi-permanent adhesive on back side surface 28 wherein applique 10 may be semi-permanently affixed to face 52 of portable device 50. When applying applique 10 of this invention, portable device 50 is preferably rendered inoperable by depressing an on/off switch or button 58. Applique 10 is then removed from carrier 21 and positioned carefully over the desired face such as face 52 and lowered into contact therewith having apertures 11, 17, 19 and 22 surrounding the respective actuating buttons 40, depression 42, elevated surfaces 64 and 48. Once positioned upon face 52, applique 10 is joined to face 52 by firmly rubbing applique 10 with the thumb of one's hand starting at a generally central position such as at elevated position 64 and working toward each edge 43-46 running the thumb over actuating buttons 40, menu keys 65 and around elevated portion 48 and depressed portion 42. It is beneficial when beginning to lay applique 10 upon face 52 to slightly curl applique 10 upwardly on both edges 14, 15 thereof such that a center portion of applique 10 comes in contact with face 52 first. By rubbing one's thumb firmly over keys 40, 65 and applique 10, applique 10 becomes firmly adhered to face 52.

Applique 10 is deposited on carrier 21 as in an approximate shape of applique 10 though the approximate shape is uncut. Decorative surface 34 of applique 10 is created in a computer program as an image and therefore may comprise stock images for sale to the general public in pairs as described below or as individual appliques created expressly for an individual and/or a company. As each applique 10 may be created individually, each applique 10, 33 for a specific customer may thus be very personalized having the company name, if any, and the individual's name created in decorative surface 34 of personalized applique 33 and/or decorative surface 34 of applique 10. In fact, the entirety of applique 10 may be personalized by providing an image comprised of the individual's name as decoration 34 wherein face 52 may show the individual's name over the entirety of face 52 as one image with cutouts 11, 17, 19 and 22 disposed therethrough or as multiple images of the individual's name showing between cutouts 11, 17, 19 and 22. Stock images of decoration 34 may be made relatively inexpensively on a large printing press creating numerous stock images of decoration 34 on the printing sheet at one time whereas individualized decorations 34 are made on a smaller printer such as an Impressa Printer 2 Digital Label & Decal Press available from Primera Technology, Inc., Plymouth Minn., U.S.A. Normally, in short runs on such a smaller printer, a complete label sheet of thirty images is created at one time each image comprising one applique 10 or applique 33 though each applique 10, 33 may be different as recited above. As any decoration 34 may be created for applique 10, 33, photos, drawings, company logos, advertising slogans, names, maps and the like may be used. A die having knife edges outlining each of apertures 11, 17, 19 and 22 along with slits 16 and 20 is located over the uncut shape. The die is brought into contact with upper surface 31 of applique material 25 and forced through applique material 25 from top side surface 31 through bottom side surface 28 leaving a mark on carrier 21 in the outline of each of apertures 11, 17, 19, 22 and slits 16, 20 while defining each of external edges 12-15 of applique 10 including notch 18. The distance from side 14 to side 15 is defined as the distance between edge 45 and 46 over the contoured surface of face 52 of portable device 50 while the distance from top end 12 to bottom end 13 is defined as the distance over the curved portion of face 52 from bottom edge 44 to top edge 43 such that applique 10 will conform to the entirety of contoured surface of face 52. Upon completion of one cut through applique material 25, the die is moved to another uncut shape and the process repeated. The uncut shapes deposited on carrier 21 may be arranged in the pairs of appliques 10 as will be packaged together wherein the pairs of appliques 10 may then be cut apart as adjacent pairs of appliques 10 on a section of carrier 21 and thereafter folded in half between the pairs of appliques 10. The pairs of appliques 10 are then placed in a suitable container affixed with a hanging tag having advertising and pricing information thereon for sale at retail. Though it is contemplated to produce the pairs of appliques 10 for sale at retail, it is also possible to provide applique 10 with information specific to a particular company for attachment to each portable device owned by the company or leased by the company for use by individuals of the company. Thus, a company may have advertising space on each portable device on personalized applique 33 appearing on back face 53 or on side faces 55, 56 while allowing the individual using the portable device to personalize the front face 52.

Applique 10 for hand held device 50 thus comprises a thin sheet of applique material 25 having adhesive on back side surface 28 and decoration 34 on top side surface 31 of thin sheet of material 25, applique 10 having a series of cutouts 11, 17, 19, 22 disposed through thin sheet of material 25, cutouts 11, 17, 19, 22 conforming to contoured surface 59 of hand held device 50 and surrounding a series of projections 40, 65, 63 projecting from face 52 and also surrounding a depression 42 formed into face 52 of hand held device 50. Means 49 for acting may protrude from face 52 as is conventional with most hand held devices 50 wherein cutouts 11 and 19 surround means 49 for actuating protruding above face 52. However, means 49 for actuating may be recessed into face 52 or may alternately be coplanar with contoured surface 59, cutouts 11 and 19 surrounding the area of each of means 49 for actuating. Though applique 10 is generally used to change the appearance of a smaller unit such as hand held device 50, it is contemplated that an applique 10 may be constructed and applied according to the teachings of this invention to larger units having a contoured face such as face 52 of a computer keyboard, with projections projecting above face 52, recessed into face 52 or coplanar with contoured surface 59.

While the present invention has been described with reference to the above described preferred embodiments and alternate embodiments, it should be noted that various other embodiments and modifications may be made without departing from the spirit of the invention. Therefore, the embodiments described herein and the drawings appended hereto are merely illustrative of the features of the invention and should not be construed to be the only variants thereof nor limited thereto.

I claim:

1. In a portable device having a case housing electronic components, said case comprising a cubic structure having at least one contoured face, at least one said face further having a plurality means for actuating thereon for operating said portable device, the improvement wherein the appearance of at least one face of said case is changeable by removably affixing one of a plurality of decorative appliques thereto, said decorative applique having apertures disposed therein for accessing said plurality of means for actuating therethrough.

2. A portable device as in claim 1 wherein said face having said plurality of means for actuating therein is contoured from one edge thereof to an opposite edge thereof said applique conforming to said face from said one edge to said opposite edge.

3. A portable device as in claim 2 wherein said face contoured from said one edge thereof to said opposite edge thereof is further contoured from one end to an opposite end thereof said applique conforming to said face from said one edge to said opposite edge and from said one end to said opposite end.

4. A portable device as in claim 3 wherein said face contoured from said one edge thereof to said opposite edge thereof and contoured from said one end to said opposite end thereof has contoured depressions disposed downwardly into said face between said one edge and said opposite edge and between said one end and said opposite end.

5. A portable device as in claim 3 wherein said face contoured from said one edge thereof to said opposite edge thereof and contoured from said one end to said opposite end thereof has contoured elevations disposed upwardly from said face between said one edge and said opposite edge and said one end and said opposite end.

6. A portable device as in claim 5 wherein said applique conforms to said contoured face and is applied to said face from said one edge to said opposite edge, from said one end to said opposite end, around said means for actuating, said depressions and said elevations.

7. A portable device as in claim 1 wherein said applique conforms to said at least one said contoured face.

8. A portable device as in claim 1 wherein said portable device is adapted for communication with a base unit, said case housing electronic components to effect said communication with said base unit.

9. A portable device as in claim 1 wherein each said aperture of said decorative applique is individually contoured around each of said plurality of means for actuating.

10. A portable device as in claim 3 wherein said portable device is a hand held device.

11. A portable device as in claim 1 wherein said decorative applique is removed from said t least one said face and another applique is applied to said at least one said face.

12. A portable device having a case housing electronic components, said case comprising a cubic structure having at least one contoured face, said at least one said face further having a plurality of means for actuating thereon for operating said portable device, wherein the appearance of at least one face of said case is changed by affixing one of a plurality of decorative appliques thereto, said one of said decorative appliques having apertures disposed therein for accessing said means for actuating therethrough.

13. A portable device as in claim 12 wherein said one of said plurality of decorative appliques is applied to said at least one said face of said case and another of said plurality of decorative appliques is applied to another of said at least one said faces.

14. A portable device as in claim 12 wherein said one of said plurality of decorative appliques is removed from a carrier sheet while leaving an applique cutout conforming to each said aperture upon said carrier sheet.

15. An applique adapted for being adhesively affixed to at least one face of a hand held device wherein said hand held device comprises a case housing electronic components, said case comprising a cubic structure having at least one contoured surface on said at least one said face thereof, said at least one said face further having a plurality of means for actuating disposed thereon, said plurality of means adapted to actuate said portable device, the appearance of said face of said hand held device changed by application of said applique thereto, said applique selected from a group of appliques permitting the owner of said hand held device to personalize said hand held device.

16. An applique as in claim 15 wherein said applique is removed from a carrier sheet while leaving an cutout conforming to each said aperture upon said carrier sheet.

17. An applique as in claim 16 wherein said applique has means for permitting said applique to conform to said contoured surface.

18. An applique as in claim 17 wherein said means for permitting comprises a between at least two of said apertures.

19. An applique as in claim 18 wherein said at least one said face has at least one contoured side edge and at least one contoured end, said at least one said contoured end having a depression formed into said face adjacent said at least one said contoured end wherein said slit is disposed between said at least one said end and said depression.

20. An applique as in claim 18 wherein said at least one said face has at least one contoured side edge and at least one contoured end, said at least one said contoured end having an elevation formed upon said face adjacent at least one said means for actuating wherein said slit is disposed between an aperture surrounding said at least one said means for actuating and an aperture surrounding said elevation.
